(19) United States
(12) Patent Application Publication
(10) Pub. No.: US 2008/0118742 A1
(43) Pub. Date: May 22, 2008

(54) Heat Spreading Member And Manufacturing Method Thereof

(75) Inventors: Shin-ichiro Yokoyama, Shimane (JP); Kiminori Sato, Shimane (JP)

Correspondence Address: LOWE HAUPTMAN HAM & BERNER, LLP, 1700 DIAGONAL ROAD, SUITE 300, ALEXANDRIA, VA, 22314, US

(73) Assignees: HITACHI METALS, LTD., Minato-ku, Tokyo (JP); SHIMANE PREFECTURAL GOVERNMENT, Matsue-shi, Shimane (JP)

(21) Appl. No.: 11/575,649

(22) PCT Filed: Feb. 15, 2006
(86) PCT No.: PCT/JP2006/302668

§ 371 Date: Mar. 20, 2007

(30) Foreign Application Priority Data
Feb. 16, 2005 (JP) 2005-039171

(51) Int. Cl. B32B 5/02; B05D 3/04

(52) U.S. Cl. 428/332; 428/221; 427/535

(57) ABSTRACT

A heat dissipating member composed of a composite material of carbon fibers being substantially aligned in one direction and copper, characterized in that the metal structure of the above copper in the heat dissipating member is a recrystallized structure. The above heat dissipating member is composed of a composite material of carbon fiber and copper, and exhibits high thermal conductivity.

### RELATED APPLICATIONS

The present application is a National Phase application based on International Application Number PCT/JP2006/302668, filed Feb. 15, 2006, which claims priority from, Japanese Patent Application No.2005-039171, filed Feb. 16, 2005, the disclosures of which is hereby incorporated by reference herein in its entirety. cl TECHNICAL FIELD

The present invention relates to a heat spreading member which serves to dissipate around heat generated from electronic devices such as semiconductor devices, imaging devices, optical devices, and a manufacturing method thereof.

### BACKGROUND ART

Amount of heat generated from components of electronic devices such as semiconductor devices, imaging devices, and optical devices increases along with increased processing speed and degree of integration of the semiconductor devices such as laptop personal computers, increased luminance of the imaging devices such as liquid crystal televisions and plasma displays, and increased power of the optical devices such as light emitting diodes (LEDs). Heat generation in the electronic devices can cause malfunction and/or failure. Therefore, techniques for dealing with heat generation have conventionally been regarded as significant.

In the devices as mentioned above, copper and/or aluminum are employed as a material for casings and/or radiator plates to dissipate the heat to surroundings, since these materials have particularly high thermal conductivity even among metal materials. However, even though the copper has favorable thermal conductivity among the metal materials, the thermal conductivity thereof is still approximately 400 W/(m−K). In addition, the density of copper is large as 8.9 Mg/m³, in other words, the copper is disadvantageous in that it is bulky and heavy.

Hence, some propose in recent years to manufacture and employ a composite material of carbon fibers and a metal material for a heat spreading member by using carbon fibers, which are light and highly heat conductive, instead of the metal materials mentioned above.

For example, Japanese Patent Application Laid-Open No. 2003-46038 (Patent Document 1) describes a method of manufacturing a composite material of carbon fibers and a metal material, and the method includes plating carbon fibers with a metal such as nickel and copper, and impregnating the plated carbon fibers with a hot solution of the metal material for liquid metal forging. Further, the above document describes a method which includes plating the carbon fibers with a metal, and hot pressing the plated carbon fibers to sinter and solidify the same into shapes. According to the latter method using the hot pressing, the metal plating on surfaces of the carbon fibers serve as a buffer at a time of the hot pressing and also serve as a joining agent filling up gaps between carbon fibers.

As can be seen from the above, the methods which include plating of the carbon fibers can be regarded as effective techniques for forming a composite of the carbon fibers and a metal material.

Patent Document 1: Japanese Patent Application Laid-Open No. 2003-46038

### DISCLOSURE OF INVENTION

### PROBLEM TO BE SOLVED BY THE INVENTION

The method described in Patent Document 1 mentioned above is regarded as an effective technique for manufacturing a heat spreading member composed of a composite material of carbon fibers and a metal material.

Incidentally, the thermal conductivity of carbon fibers is not less than 500 W/(m−K), and is typically approximately within the range of 800 W/(m−K) to 1000 W/(m−K). When the carbon fibers are combined with a metal material which has lower thermal conductivity than the carbon fibers and form a composite material, however, thermal conductivity decreases. Hence, there is a need for a heat spreading member composed of a composite material whose thermal conductivity shows little decrease compared with a separate material.

In view of the foregoing, an object of the present invention is to provide a heat spreading member which is composed of a composite material of carbon fibers and a metal material and has high thermal conductivity, and a manufacturing method thereof.

### MEANS FOR SOLVING PROBLEM

The inventors of the present invention took a particular note on copper which has high thermal conductivity among metals and is inexpensive, and found that a morphological structure of a copper portion in a heat spreading member composed of a composite material of carbon fibers and copper has a close connection with the thermal conductivity of the heat spreading member, thereby reaching the present invention.

Namely, the present invention relates to a heat spreading member composed of a composite material of carbon fibers aligned substantially in one direction and copper, wherein a metal structure of the copper in the heat spreading member is a recrystallized structure.

The present invention preferably relates the heat spreading member, wherein an average crystal grain size of the recrystallized structure is 0.1 μm to 20 μm.

Further, the present invention relates the heat spreading member, wherein a volume fraction V_{CF} of a portion of the carbon fibers in the heat spreading member is 30 percent to 90 percent, and more preferably the volume fraction V_{CF} is 30 percent to 60 percent. The present invention relates the heat spreading member, wherein at least one carbon fiber is present in any of 50 μm square portions in a field of view in a section perpendicular to a direction of the carbon fibers, and more preferably the section perpendicular to the direction of the carbon fibers is not smaller than 1 mm square.

Furthermore, the present invention relates the heat spreading member, wherein a relation

ρ/{ρ_{CF}×(V_{CF}/100)+ρ_{CU}/100)}≧0.9

is satisfied, where p (Mg/m³) is density of the heat spreading member, ρ_{CF}(Mg/m³) is density of the carbon fibers, V_{CF} (%) is the volume fraction of the carbon fibers, ρ_{CU}(Mg/m³) is density of the copper, and V_{CU} (%) (=100−V_{CF}) is an apparent volume fraction of the copper.

The present invention relates a manufacturing method of the heat spreading member, comprising: plating copper on surfaces of carbon fibers of a diameter d_{CF} to a thickness of (0.05 to 0.60)×d_{CF}; aligning the plated carbon fibers substantially in one direction; and performing spark plasma sintering on the aligned plated carbon fibers and recrystallizing a metal structure of the copper under conditions of 600° C. to 1050° C. in a highest temperature, 5 MPa to 100 MPa in a highest pressure, and 0.1 ks to 1.8 ks in a time length of a period when the highest temperature is maintained in ±5° C.

### EFFECT OF THE INVENTION

According to the present invention, the thermal conductivity of the heat spreading member can be significantly increased. Thus, the present invention can provide an indispensable technique for devices, which require heat control, such as semiconductor devices, imaging devices, and optical devices.

### BEST MODE(S) FOR CARRYING OUT THE INVENTION

As described above, a primary feature of the present invention lies in that, in the heat spreading member composed of the composite material of the carbon fibers aligned substantially in one direction and copper, the metal structure of a copper portion in the heat spreading member is the recrystallized structure so as to make the thermal conductivity of the heat spreading member high. The metal structure is made to be the recrystallized structure because the recrystallized structure of copper is a necessary structure for increasing the thermal conductivity of the copper portion in the heat spreading member, and for increasing the thermal conductivity of the heat spreading member as a whole.

As described above, the thermal conductivity of copper is said to be approximately 400 W/(m−K). However, when there is a lattice defect such as dislocation and vacancy caused by plastic working in copper crystal, such lattice defect obstructs heat conduction, thereby decreasing the thermal conductivity below 400 W/(m−K). Therefore, it is necessary to form the recrystallized structure with no lattice defect in the copper portion of the heat spreading member in order to realize the original thermal conductivity of copper, i.e., the thermal conductivity of approximately 400 W/(m−K), and to enhance the thermal conductivity of the heat spreading member.

With such a structure, the thermal conductivity of copper, which is a base material (base) of the composite material, can be significantly improved, and the heat spreading member can be made to have high thermal conductivity.

In the present invention, the recrystallized structure means a metal structure which can be observed in a structure that undergoes thorough recrystallization, and does not imply a metal structure which can be observed in a structure containing a non-recrystallized portion where the recrystallization is imperfect. The recrystallized structure is defined as above because the lattice defect remains in the non-recrystallized portion and decreases the thermal conductivity.

In addition, though the present invention does not designate a type of the copper that composes the heat spreading member in particular, it is desirable that the copper be pure copper whose purity is not less than 99 mass percent in order to obtain the heat spreading member with high thermal conductivity. The above purity is desirable because the thermal conductivity significantly decreases when copper contains alloy element more than 1 mass percent. More desirably, the purity of copper is not less than 3N (99.9 mass percent). In the description, the purity of copper means concentration (mass percent) of copper in the copper portion of the heat spreading member as analyzed and measured by an energy dispersive X-ray analyzer attached to a scanning electron microscope or a wavelength dispersive X-ray analyzer attached to an electron probe microanalyzer after mirror polishing of a relevant section of the heat spreading member.

Next, reasons why a desirable range of the average crystal grain size in the copper portion is defined will be described.

The lower limit of the average crystal grain size is set to 0.1 μm, in order to reduce the amount of grain boundaries present in the recrystallized structure of the base material (copper portion) and facilitate heat conduction. The grain boundaries hinder heat conduction. If there are large amount of grain boundaries in the recrystallized structure, the thermal conductivity of the heat spreading member may be decreased. Therefore, the desirable lower limit of the average crystal grain size in the recrystallized structure is set to 0.1 μm to more surely secure the original thermal conductivity of copper, i.e., the thermal conductivity of approximately 400 W/(m−K) in the base material (copper portion) in the heat spreading member.

On the other hand, if the volume fraction of carbon fibers in the heat spreading member is increased, the volume fraction of the base material (copper portion) is decreased. Then, the growth of the crystal grains in the recrystallized structure of the base material is hindered by the carbon fibers. Therefore, the volume fraction of the carbon fibers has a large significance on the upper limit of the average crystal grain size of the recrystallized structure. In view of a preferable volume fraction of the carbon fibers described later, the upper limit of the recrystallized grain size may preferably be 20 μm. More desirably, the range of the average crystal grain size is 0.5 μm to 10 μm.

Further, in the present invention, the volume fraction V_{CF} of the carbon fiber portion in the heat spreading member is set to 30 percent to 90 percent. Firstly, this is because the carbon fibers do not exert much influence to increase the thermal conductivity when the volume fraction thereof is less than 30 percent. Secondly, when the volume fraction is more than 90 percent, the amount of copper which serves as a joining agent that fills up the spaces between carbon fibers is significantly smaller than the amount of carbon fibers, and therefore it is difficult to form the heat spreading member in which the carbon fibers and copper are homogenously combined.

When the heat spreading member is required to have high thermal conductivity also in a transverse direction (hereinafter simply referred to as vertical direction) of the direction of the carbon fibers, or when the heat spreading member is required to have reliability in a high temperature environment or a heat cycle, or when the heat spreading member is required to have a mechanical strength, V_{CF} is more desirably in the range of 30 percent to 60 percent.

When the ratio of the carbon fibers in the heat spreading member increases, the thermal conductivity in the direction of carbon fibers is increased while the thermal conductivity in the vertical direction is decreased. In addition, if the heat spreading member, in which the amount of copper that is present between adjacent carbon fibers is small, is left in a high temperature environment during use, copper may undergo plastic flow to form a gap around the carbon fibers because copper and carbon fibers do not have favorable wettability. Then, the heat spreading character of the heat spreading member may be degraded. Still in addition, when the amount of copper present between the adjacent carbon fibers is small, the number of week boundaries between carbon fibers and copper increases. Then, the strength of the heat spreading member as a whole is deteriorated. In such case, if the heat spreading member is placed under the heat cycle and the thermal stress is high, cracks might be generated in the heat spreading member. In consideration of the above, a more desirable range of the volume fraction of the carbon fibers is set to 30 percent to 60 percent.

In the present invention, the volume fraction of the carbon fibers is substantially equal to an area fraction of the carbon fibers in a section which is perpendicular to the direction of carbon fibers in the heat spreading member as observed within a field of view of an optical microscope after the section is subjected to mirror polishing. Therefore, the volume fraction can be estimated based on the observation of the section.

More specifically, when viewed through the optical microscope, the section of the heat spreading member appears to be white in the copper portion while appearing to be black in the carbon fiber portion. An image observed via the optical microscope may be digitized into black and white, and an area fraction of a black portion in the image may be found. Thus, the area fraction of the carbon fibers in the field of view can be measured. It should be noted, however, that a slight gap along the boundary of the carbon fibers and copper appears to be black when viewed through the optical microscope. Therefore, the area fraction of the carbon fiber obtained according to the above manner of measurement is larger than an actual area fraction. In the present invention, however, the area of the gap portion in the heat spreading member is trivial in comparison with the area occupied by either of the carbon fiber portion or the copper portion. Therefore, the gap portion can be ignored in the measurement of the area fraction of the carbon fibers.

In the present invention, a type (such as PAN-type and pitch-type) of the carbon fibers composing the heat spreading member is not specified in particular. The carbon fibers, however, desirably have a graphite structure and are 5 μm to 20 μm in diameter, in order to form the heat spreading member with high thermal conductivity. Here, it is desirable to use the carbon fibers of the same diameter size in order to obtain the member in which the section perpendicular to the direction of carbon fibers has a homogenous structure. However, if it is desirable to fill the heat spreading member with the carbon fibers at a high density to further increase the volume fraction of the carbon fibers, different types of carbon fibers having different sizes of diameters ranging from 5 μm to 20 μm may be employed together. In addition, in order to align the copper-plated carbon fibers substantially in one direction following a later-mentioned method of manufacturing the heat spreading member, the carbon fibers are desirably continuous fibers that are at least 100 mm in length.

As mentioned earlier, it is desirable that at least one or more carbon fibers be present in a section which is perpendicular to the direction of carbon fibers in the heat spreading member in any of 50 μm square portions within the field of view. This is because it is desirable that the carbon fibers be distributed in the heat spreading member as homogenously as possible. When the distribution of the carbon fibers is nonhomogenous, the thermal conductivity of the heat spreading member can be decreased since the heat is dissipated slowly in a portion where the carbon fibers are sparse while the heat is dissipated rapidly in a portion where the carbon fibers are dense. The distribution of carbon fibers can be regarded as substantially homogenous if at least one or more carbon fibers are present within any of the 50 μm square portions within the field of view. Desirably, at least five or more carbon fibers should be present in any of the 50 μm square portions within the field of view.

As mentioned earlier, the heat spreading member desirably has at least 1 mm square section perpendicular to the direction of the carbon fibers. The size of the section is defined as above because such is a desirable size for the heat spreading member employed in the electronic devices. For example, assume that the heat spreading member of the present invention is mounted on a light emitting package which includes a chip of a large-output light emitting diode (LED) (hereinafter such a chip will be referred to as LED chip) and the LED chip is sealed with resin. When the section perpendicular to the direction of carbon fibers in the heat spreading member is brought into contact with a bottom surface of the LED chip, heat generated by the LED chip can be transferred from inside the light emitting package to outside. Therefore, it is desirable for efficient heat transfer that the heat spreading member has a contact surface whose area is larger than the area of the bottom surface of the LED chip. Since the area of the bottom surface of the large-output light emitting diode is approximately 1 mm square in general, the size of the section perpendicular to the direction of carbon fibers in the heat spreading member is set not to be smaller than 1 mm square. More desirably, the area is not smaller than 1.5 mm square.

Further, as mentioned earlier, the relation expressed by

ρ/{ρ_{CF}×(V_{CF}/100)+ρ_{CU}×(V_{CU}/100)}≧0.9

should be satisfied as the desirable range, where ρ(Mg/m³) is the density of the heat spreading member, ρ_{CF}(Mg/m³) is the density of carbon fibers, V_{CF} (%) is the volume fraction of the carbon fibers, ρ_{CU}(Mg/m³) is the density of copper, and V_{CU} (%) (=(100-V_{CF})) is the apparent volume fraction of copper. The relation is defined as above in order to provide the heat spreading member with high thermal conductivity.

The value of {ρ_{CF}×(V_{CF}/100)+ρ_{CU}×(V_{CU}/100)} described above corresponds to a theoretical density of the heat spreading member, i.e., an ideal density thereof. Hence, the value of ρ/{ρ_{CF}×(V_{CF}/100)+ρ_{CU}×(V_{CU}/100)} corresponds to a relative density. The closer the value to one, the smaller the amount of gap contained in the composite material. The presence of gap in the heat spreading member obstructs the heat conduction, thereby lowering the thermal conductivity of the heat spreading member. Such inconvenience is particularly prominent when the value of ρ/{ρ_{CF}×(V_{CF}/100)+ρ_{CU}×(V_{CU}/100)} is smaller than 0.9. Therefore, the desirable range is set as

ρ/{ρ_{CF}×(V_{CF}/100)+ρ_{CU}×(V_{CU}/100)}≧0.9

### More desirably,

ρ/{ρ_{CF}×(V_{CF}/100)+ρ_{CU}×(V_{CU}/100)}≧0.93.

According to the manufacturing method of the present invention, in a pretreatment for combining the carbon fibers and copper, the copper is plated on the carbon fibers. Primary feature of this treatment is that the homogenous combining of the carbon fibers and copper, in other words, the adjustment of plating thickness can make intervals between joined carbon fibers approximately equal to each other. Therefore, fluctuation in the heat spreading characteristic within a plane can be decreased, which is significant in terms of the quality of the heat spreading member. Further, the above method is suitable for industrial mass production in terms of economic efficiency and reproducibility.

Further, in the desirable manufacturing method to obtain the heat spreading member as described above according to the present invention, the thickness of copper plating and a condition for solidifying the copper plated carbon fibers into shape are defined. The reason for such definitions in the manufacturing method of the present invention will be described below.

The thickness of the copper plating applied on a surface of the carbon fibers is defined to be (0.05 to 0.60)×d_{CF}, where d_{CF} stands for the diameter of the carbon fiber, because such thickness is necessary for realizing high thermal conductivity while allowing the copper plating to serve as a buffer at the same time. As far as the plating thickness is within the above described range, the volume fraction of the carbon fiber portion in the heat spreading member can be adjusted to the range of 30 percent to 90 percent after the copper plated carbon fibers are solidified into shape to form the heat spreading member composed of the composite material of the carbon fibers and copper.

When the copper plating thickness is less than 0.05×d_{CF}, the copper plating cannot exert sufficient effect as a buffer. On the contrary, when the thickness is more than 0.60×d_{CF}, the volume fraction of the carbon fiber portion in the heat spreading member is less than 30%, and it is difficult to grant a desirable high thermal conductivity to the heat spreading member. Therefore, the desirable range of the copper plating thickness is defined as described above. A more desirable range is (0.15 to 0.60)×d_{CF}. When the thickness range is (0.15 to 0.60)×d_{CF}, V_{CF} of the heat spreading member can be adjusted to a more desirable range of 30 percent to 60 percent.

After the carbon fibers are plated with copper, the carbon fibers are aligned substantially in one direction. This process serves to increase the thermal conductivity in the direction of carbon fibers in the heat spreading member.

The direction of carbon fibers may be aligned by cutting the plated carbon fibers to a predetermined length and arranging the cut carbon fibers in the same direction, for example. Alternatively, the plated carbon fibers may be folded at a uniform length. Thus, the direction of carbon fibers can be aligned substantially in one direction.

While being kept aligned substantially in one direction, the plated carbon fibers are subjected to Spark Plasma Sintering, whereby the copper plated carbon fibers are solidified into shape.

The Spark Plasma Sintering is similar to the hot pressing. However, since discharge plasma and an impact pressure of discharge generated at an initial stage of the sintering facilitate the diffusion, the Spark Plasma Sintering can finish the sintering in shorter time than the hot pressing. In the Spark Plasma Sintering, it is important to adjust the condition so that the copper portion comes to have a recrystallized structure. Since high density is not sufficient to obtain high thermal conductivity of the heat spreading member.

In the present invention, the highest temperature reached during the Spark Plasma Sintering is defined, so that the copper portion in the heat spreading member comes to have the recrystallized structure and the value of ρ/(ρ_{CF}×V_{CF}+ρ_{CU}×V_{CU}) is increased. When the highest temperature is less than 600° C., the recrystallization and the sintering of the copper portion do not progress, and it is difficult to obtain the heat spreading member having the structure and the density as defined in the present invention. On the other hand, when the highest temperature is above 1050° C., which is right below the melting point of copper (i.e., 1080° C.), the copper might melt at a slight temperature variation. Therefore, the highest temperature is determined to be within the range of 600° C. to 1050° C. A more desirable highest temperature at the Spark Plasma Sintering is 700° C. to 1000° C.

The reason why the highest pressure at the Spark Plasma Sintering is defined to be 5 MPa to 100 MPa is that the highest pressure which is less than 5 MPa is not sufficient to cause the plastic deformation which brings recrystallization in the copper portion and that the highest pressure is not sufficient to increase the value of ρ/(ρ_{CF}×V_{CF}+ρ_{CU}×V_{CU}). On the other hand, when the highest pressure is above 100 MPa, a large compressive load is required, especially when a large member is to be manufactured, which is not industrially practical. Therefore, the highest temperature is defined to be within the above described range. A more desirable pressure range is 10 MPa to 80 MPa.

Though not particularly defined in the manufacturing method of the present invention, it is desirable to apply an initial pressure before heating in order to facilitate the generation of discharge plasma at the initial stage of sintering. An amount of the initial pressure is desirably within the range of 2 MPa to 15 MPa. Further, while the pressure is increased from the level of the initial pressure to the maximum pressure, the temperature is desirably controlled to be within the range of 500° C. to 800° C.

The highest temperature ±5° C. attainable during the Spark Plasma Sintering is defined to be maintained 0.1 ks to 1.8 ks, because such a time length is necessary for facilitating the recrystallization and crystal grain growth in the copper portion of the heat spreading member. The material can be made to have high density even if the highest temperature is maintained approximately 0.06 ks, which is shorter than 0.1 ks, for example. However, when the highest temperature is maintained only for such a short time, the recrystallization and the crystal grain growth in the copper portion is not sufficient, and as a result, high thermal conductivity is difficult to obtain. Therefore, the lower limit of the required time length is set to be 0.1 ks. On the other hand, when the required time length exceeds 1.8 ks, the process takes too long and not industrially practical. Therefore, the upper limit of the required time length is set to be 1.8 ks. A more desirable range of the required time length is 0.2 ks to 1.2 ks.

Though not specifically defined according to the manufacturing method of the present invention, a degree of vacuum at the Spark Plasma Sintering is desirably higher than 100 Pa in order to prevent the oxidization of copper, as the copper oxidization hampers the sintering. More desirably, the degree of vacuum is higher than 50 Pa.

### EXAMPLE 1

The present invention will be described in more detail based on following examples.

In the first example, pitch-type carbon fibers are employed as the carbon fibers with high thermal conductivity. Further, the carbon fibers employed in the first example have the same diameter. The diameter d_{CF} of the carbon fiber is, as can be seen from a photograph of FIG. 1 taken via an electron scanning microscope, 10 μm. The carbon fibers employed in the first example is commercially available in a form of approximately 2,000 continuous fibers of approximately 270 m in length bound together and wound around a bobbin.

The nominal thermal conductivity of the carbon fibers is 800 W/(m−K), and the density ρ_{CF} is 2.2 Mg/m³. When the structure of the carbon fibers is checked by X-ray diffraction, it is found that the carbon fibers have a graphite structure.

After the carbon fibers are cut into 500 mm pieces, electroless copper plating is performed on the cut pieces with a target thickness set to six different levels within the range of 0.8 μm (=0.08×d_{CF}) to 5.0 μm (=0.50×d_{CF}). All the set plating thicknesses are within the range defined according to the manufacturing method of the present invention.

As an example, a photograph taken via a scanning electron microscope of a surface of a carbon fiber on which copper plating is applied to the thickness of 5 μm is shown in FIG. 2. The surface morphology after the plating is obviously different from that before the plating (FIG. 1), and fine particles of copper are deposited on the surface of the carbon fiber. Further, the copper plated carbon fiber is buried in resin and a section thereof is observed via an optical microscope. A photograph of the section is shown in FIG. 3. It can be seen that the copper plating (2) is applied on the surface of the carbon fiber (1) to a substantially uniform thickness.

After the copper plating is applied on the carbon fibers with the target thickness set to six different levels, the carbon fibers are cut into pieces of either 20 mm or 40 mm in length. Thereafter, the cut pieces are aligned substantially in one direction and put into a graphite mold. The graphite mold is placed in a chamber of a Spark Plasma Sintering machine and vacuumed up to approximately 10 Pa.

First, an initial pressure of 12.5 MPa is applied in a compression direction, followed by heating up and pressurization. Thus, heat spreading members A to G are manufactured in size of either 5 mm×20 mm×20 mm or 5 mm×40 mm×40 mm under seven different conditions shown in Table 1. Among the members A to G, A to F are the heat spreading members manufactured according to the manufacturing method of the present invention. In Table 1, “time” means a time length of a period when the temperature is within the range of the highest temperature ±5° C.

The heat spreading member A is manufactured under the condition that the target thickness of copper plating is 0.8 μm, the highest temperature during the Spark Plasma Sintering is 900° C., the highest pressure is 50 MPa, and the time is 0.90 ks. The heat spreading members B to F are manufactured under the same condition of the Spark Plasma Sintering as the member A with the target thickness of copper plating set to 1.0 μm (B), 2.5 μm (C), 3.0 μm (D), 4.0 μm (E), and 5.0 μm (F), respectively.

On the other hand, the heat spreading member G is manufactured according to a method of a comparative example. The member G is the same as the members A to F in that the copper plating of 5.0 μm in thickness is applied, and the highest temperature and the highest pressure in the following Spark Plasma Sintering are 900° C. and 50 MPa. However, the time the member G is maintained at 900° C. is short, i.e., 0.06 ks, which is out of the range defined according to the manufacturing method of the present invention.

TABLE 1

| | Diameter of | Target Thickness | Condition of Spark Plasma Sintering | | | |
|---|---|---|---|---|---|---|
| Heat Spreading | Carbon Fiber d_{CF} | of Copper Plating | Highest Temperature | Highest pressure | Time | |
| Member | (μm) | (μm) | (° C.) | (MPa) | (ks) | Note |
| A | 10 | 0.8 | 900 | 50 | 0.90 | Present invention |
| B | 10 | 1.0 | 900 | 50 | 0.90 | Present invention |
| C | 10 | 2.5 | 900 | 50 | 0.90 | Present invention |
| D | 10 | 3.0 | 900 | 50 | 0.90 | Present invention |
| E | 10 | 4.0 | 900 | 50 | 0.90 | Present invention |
| F | 10 | 5.0 | 900 | 50 | 0.90 | Present invention |
| G | 10 | 5.0 | 900 | 50 | 0.06 | Comparative |
| | | | | | | example |

A sample of 5 mm×5 mm×5 mm is cut out from each of the heat spreading members and buried into resin so that a section perpendicular to the direction of carbon fibers can be observed. Thereafter, the sample is subjected to mirror polishing and is observed via an optical microscope in an uncorroded state. A photograph of a section of the heat spreading member F viewed via the optical microscope is shown in FIG. 4 as an example of the heat spreading member of the present invention. The image shown in FIG. 4 is digitized into black and white, and an area fraction of a black portion in the image is measured. Thus, the area fraction of the carbon fiber (1) portion within the field of view is measured. The area fraction is 34.0 percent. This area fraction is equal to the volume fraction V_{CF} of the carbon fiber portion in the heat spreading member. The value of V_{CF} is measured in the same manner for each of the heat spreading members A to E and G. In addition, the copper portion of each heat spreading member is analyzed with a wavelength dispersive analyzer attached to an electron probe microanalyzer. As a result, no impurities other than copper are found, and it is confirmed that the copper is 100 percent pure in each sample.

A copper (3) portion of the heat spreading member F shown in the photograph of FIG. 4 is etched with a solution of nitric acid, sulfuric acid, and water mixed at the ratio of 1:1:184, and the structure of the member F is checked. As a result, it is confirmed that the copper (3) portion is formed with the recrystallized structure as shown in FIG. 5, and satisfies the definition required for the heat spreading member according to the present invention. Further, an average crystal grain size in the copper portion is measured through image analysis of FIG. 5, and found to be 9.1 μm.

Similarly to the member F, the copper portion of each of the heat spreading members A to E are formed of the recrystallized structure, and these members A to E are confirmed to be the heat spreading members according to the present invention. On the other hand, in the structure of the copper portion in the heat spreading member G of the comparative example, the recrystallization is imperfect as shown in FIG. 6 and the recrystallized structure cannot be observed clearly.

Table 2 shows whether the recrystallized structure is present or not, an average crystal grain size (μm) in the recrystallized structure if there is, a volume fraction V_{CF} (%) of carbon fibers, and the number of carbon fibers present in any of 50 μm square portions in the field of view with respect to the heat spreading members A to F according to the present invention and the heat spreading member F of the comparative example. The average crystal grain size of the recrystallized structure is 1.1 μm to 9.1 μm, V_{CF} is 77.0 percent to 34.0 percent, and fall within the desirable range of the present invention. In addition, it can be seen that the average crystal grain size of the recrystallized structure decreases along with the increase in the V_{CF}.

In the heat spreading member having a 5 mm square section perpendicular to the direction of carbon fibers, the number of carbon fibers in any of the 50 μm square portions in the field of view increases along with the increase in V_{CF}. In the heat spreading member F whose V_{CF} is 34.0 percent, the number of carbon fibers is six, and in the heat spreading member A whose V_{CF} is 77.0 percent, the number of carbon fibers is 13. As can be seen, in the heat spreading member of the present invention, at least one or more carbon fibers are present in any of the 50 μm square portions in the field of view in the section of at least 1 mm square, which is a desirable range. More specifically, more than five carbon fibers are present as defined as desirable. Therefore, the distribution of the carbon fibers in the heat spreading member can be deemed substantially uniform.

Further, the density ρ(Mg/m³) is determined based on measurement of weight and dimension of a remaining portion of each heat spreading member. The density ρ(Mg/m³) and relative density ρ/{ρ_{CF}×(V_{CF}/100)+ρ_{CU}×(V_{CU}/100) } of each heat spreading member are also shown in Table 2. For calculation, ρ_{CF} and ρ_{CU} are set respectively to 2.2 and 8.9. The density of each heat spreading member decreases along with the increase in V_{CF}. In the heat spreading member F whose V_{CF} is 34.0 percent, the density is 6.63 (Mg/m3), while in the heat spreading member A whose V_{CF} is 77.0 percent, the density is 3.50 (Mg/m³). The relative density of each heat spreading member is not smaller than 0.90, i.e., within the set desirable range.

Further, two samples of approximately 5 mm×5 mm×5 mm are cut out from each heat spreading member and pasted with each other with bonding agent. Thus, a sample of 10 mm×10 mm×5 mm is obtained. Here, the length of the sample along the direction of carbon fibers is 5 mm. The thermal conductivity (W/(m−K)) in the direction of carbon fibers in each heat spreading member is measured according to Laser Flash method. The results are shown in Table 2.

TABLE 2

| | | | | Number of Carbon | | | | Thermal | |
|---|---|---|---|---|---|---|---|---|---|
| | | Average | Volume | Fibers Present in | | | | Conductivity in | |
| Heat | Metal | Crystal | Fraction of | Any of 50 μm | | | | Carbon Fiber | |
| Spreading | Structure | Grain Size | Carbon Fibers | Square Portions in | Size of | Density ρ | Relative | Direction λ | |
| Member | of Copper | (μm) | V_{CF} (%) | Field of View | Section | (Mg/m³) | Density | (W/(m · K)) | Note |
| A | Recrystallized | 1.1 | 77.0 | 13 | 5 mm | 3.50 | 0.94 | 675 | Present |
| | | | | | square | | | | Invention |
| B | Recrystallized | 1.5 | 73.2 | 13 | 5 mm | 4.00 | 0.98 | 726 | Present |
| | | | | | square | | | | Invention |
| C | Recrystallized | 3.6 | 49.2 | 8 | 5 mm | 5.35 | 0.95 | 644 | Present |
| | | | | | square | | | | Invention |
| D | Recrystallized | 4.2 | 45.2 | 7 | 5 mm | 5.90 | 1.00 | 704 | Present |
| | | | | | square | | | | Invention |
| E | Recrystallized | 8.5 | 37.6 | 6 | 5 mm | 5.96 | 0.93 | 593 | Present |
| | | | | | square | | | | Invention |
| F | Recrystallized | 9.1 | 34.0 | 6 | 5 mm | 6.63 | 1.00 | 570 | Present |
| | | | | | square | | | | Invention |
| G | non- | — | 33.2 | 6 | 5 mm | 6.65 | 1.00 | 508 | Comparative |
| | recrystallized | | | | square | | | | Example |

As can be seen from Table 2, when the copper portion has the recrystallized structure, and the average crystal grain size of the recrystallized structure, the V_{CF}, the number of carbon fibers present in any of the 50 μm square portions in the field of view, the relative density ρ/{ρ_{CF}×(V_{CF}/100)+ρ_{CU}×(V_{CU}/100) } are adjusted to the desirable ranges of the present invention, each of the heat spreading members A to F exhibits a high level of the thermal conductivity in the direction of carbon fibers, i.e., a level within the range of 570 W/(m−K) to 726 W/(m−K).

On the other hand, in the heat spreading member G of the comparative example, though the V_{CF}, the number of carbon fibers present in any of the 50 μm square portions in the field of view, and the relative density are substantially the same as those in the heat spreading member F of the present invention, the thermal conductivity is 508 W/(m−K), which is lower than the value in the heat spreading member F since the recrystallization of the copper portion is not finished.

According to the example 1 described above, it can be seen that to adjust the volume fraction of the carbon fibers or the density of the heat spreading member is not sufficient for obtaining high thermal conductivity in the heat spreading member composed of the composite material of carbon fibers and copper, and that higher thermal conductivity of the heat spreading member can be obtained when the copper portion is made to have the recrystallized structure as defined according to the present invention.

Manufacturing the heat spreading member based on the method as defined according to the present invention is effective for obtaining the heat spreading member as described above. Since the heat spreading member of the present invention has high thermal conductivity exceeding the thermal conductivity 400W/(m−K) of copper, the heat spreading member of the present invention is suitable as a heat spreading member for heat control in electronic devices such as semiconductor devices, imaging devices, and optical devices.

### EXAMPLE 2

Thermal conductivity (W/(m−K)) in the vertical direction of each of the heat spreading members obtained in Example 1 according to the present invention is measured according to Laser Flash method. FIG. 7 shows relation between thermal conductivity, such as the thermal conductivity in the direction of carbon fibers as measured in Example 1, and the volume fraction V_{CF} of the carbon fibers. In FIG. 7, the thermal conductivity of pure copper is shown as V_{CF}=0 for comparison. As shown in FIG. 7, the thermal conductivity in the direction of carbon fibers increases along with the increase in V_{CF}. However, the thermal conductivity in the vertical direction which is transverse to the direction of the carbon fibers significantly decreases. It can be seen that when the range of V_{CF} is adjusted to the more desirable range of the present invention, i.e., the range of 30 percent to 60 percent, the thermal conductivity can be made to 80 W/(m−K) to 200 W/(m−K) in the vertical direction as well.

Further, to evaluate reliability of the heat spreading members A, C, and D, the thermal conductivity in the direction of carbon fibers is measured after the heat spreading members are left in vacuum at high temperature. The results are shown in FIG. 8. As shown in FIG. 8, along with the increase in the temperature in which the heat spreading members are left, the thermal conductivity decreases in every heat spreading member. However, it is confirmed that the decrease in thermal conductivity is particularly significant in the heat spreading member A, which has a high volume fraction of carbon fibers and the V_{CF} is 77.0 percent, when the heat spreading member A is left at 800° C. for 24 hours. The structure of the heat spreading member A after being left in the high temperature is observed. The results are shown in FIG. 10. In the structure, gaps which are not observed before the test can be observed, and it is assumed that the plastic flow of copper occurs under the high temperature. Such phenomenon is assumed to be caused by an unfavorable wettability of the carbon fibers and copper, and attributable to a small amount of copper present between the carbon fibers. On the other hand, when the heat spreading member D whose V_{CF} is 46.1 percent is left at 800° C. for 24 hours and the structure is observed in the same manner, no prominent changes in structure are observed as can be seen in FIG. 9. Therefore, to secure the reliability under the high temperature environment, it is more desirable to adjust the range of V_{CF} to the range of 30 percent to 60 percent.

Further, a sample of 5 mm×5 mm×40 mm is cut out from each of the heat spreading members A and D. A three-point bending test is performed on the samples with the span set to 30 mm and displacement speed set to 0.5 mm/minute, to measure a load-displacement curve. The results of the measurement are shown in FIG. 11. In FIG. 11, “fiber direction” indicates the sample in which the direction of a 40 mm side corresponds to the direction of carbon fibers, and “vertical direction” indicates the sample in which the direction of the 40 mm side corresponds to the direction perpendicular to the carbon fiber. In each heat spreading member, the strength in the vertical direction is lower than the strength in the fiber direction. It can be seen, however, that the decrease of deflective load is particularly significant in the heat spreading member A in which the V_{CF} is 77.0 percent and the volume fraction of carbon fibers is large. The cause is assumed to be the presence of many weak boundaries of carbon fibers and copper in the heat spreading member A. Based on the value of maximum load and the dimension of the samples as represented by each of the load-displacement curves of FIG. 11, the deflective strength a (MPa) of each heat spreading member is determined according to a following expression (1). The results are shown in Table 3.

σ=(3×W×L)/(2×b×t²) (1).

### In the expression (1), W is the maximum load (N), L is the span (=30 mm), b is the width of the sample (=5 mm), and t is the thickness of the sample (=5 mm).

TABLE 3

| | |
|---|---|
| Heat Dissipating | Deflective Strength (MPa) |

| Member | Fiber Direction | Vertical Direction |
|---|---|---|
| A | 224.8 | 6.7 |
| D | 411.1 | 72.6 |

A temperature cycling test is performed on the heat spreading members A and D up to 200 cycles. In one cycle, room temperature is maintained for 10 minutes, −40° C. is maintained 10 minutes, room temperature again for 10 minutes, and 125° C. for 10 minutes. The structures of the heat spreading members A and D after the temperature cycling test are shown in FIGS. 12 and 13, respectively. In the heat spreading member A in which V_{CF} is at a high level of 77.0 percent, cracks are generated after the test (FIG. 12), whereas in the heat spreading member D in which V_{CF} is 46.1 percent, no cracks are observed (FIG. 13). Therefore, to secure the reliability with respect to the mechanical strength and the temperature cycling test, more desirably the range of V_{CF} is adjusted to the range of 30 percent to 60 percent.

As can be seen from the Example 2 described above, when the heat spreading member is required to have high thermal conductivity in the vertical direction perpendicular to the carbon fibers, or when the heat spreading member is required to have reliability under the high temperature environment and the heat cycle, or when the heat spreading member is required to have a mechanical strength, more desirably the range of V_{CF} is set to the range of 30 percent to 60 percent.

### BRIEF DESCRIPTION OF DRAWINGS

FIG. 1 is a photograph of a surface of a carbon fiber employed in the present invention, the photograph being taken by a scanning electron microscope;

FIG. 2 is a photograph of a surface of a carbon fiber after copper plating according to a manufacturing method of the present invention, the photograph being taken by a scanning electron microscope;

FIGS. 3A and 3B are photographs of sections of the carbon fiber after copper plating according to the manufacturing method of the present invention, the photographs being taken by an optical microscope;

FIGS. 4A and 4B are photographs of sections perpendicular to the carbon fiber in the heat spreading member according to the present invention, the photographs being taken by an optical microscope;

FIG. 5 is a photograph of a structure of a copper portion in the heat spreading member according to the present invention, the photograph being taken by an optical microscope;

FIG. 6 is a photograph of a structure of a copper portion in a heat spreading member of a comparative example, the photograph being taken by an optical microscope;

FIG. 7 shows an influence of a volume fraction of carbon fibers on thermal conductivity of the heat spreading member of the present invention;

FIG. 8 shows an influence of a temperature at which the heat spreading member is left on the thermal conductivity of the heat spreading member of the present invention;

FIG. 9 is an example of a photograph of a structure of the heat spreading member according to the present invention after left at a high temperature for testing, the photograph being taken by a scanning electron microscope;

FIG. 10 is another example of a photograph of a structure of the heat spreading member according to the present invention after left at a high temperature for testing, the photograph being taken by a scanning electron microscope;

FIG. 11 is a load-displacement curve on deflective test of the heat spreading member of the present invention;

FIG. 12 is an example of a photograph of a structure after a temperature cycling test of the heat spreading member of the present invention, the photograph being taken by an optical microscope; and

FIG. 13 is an example of a photograph of a structure after a temperature cycling test of the heat spreading member of the present invention, the photograph being taken by a scanning electron microscope.

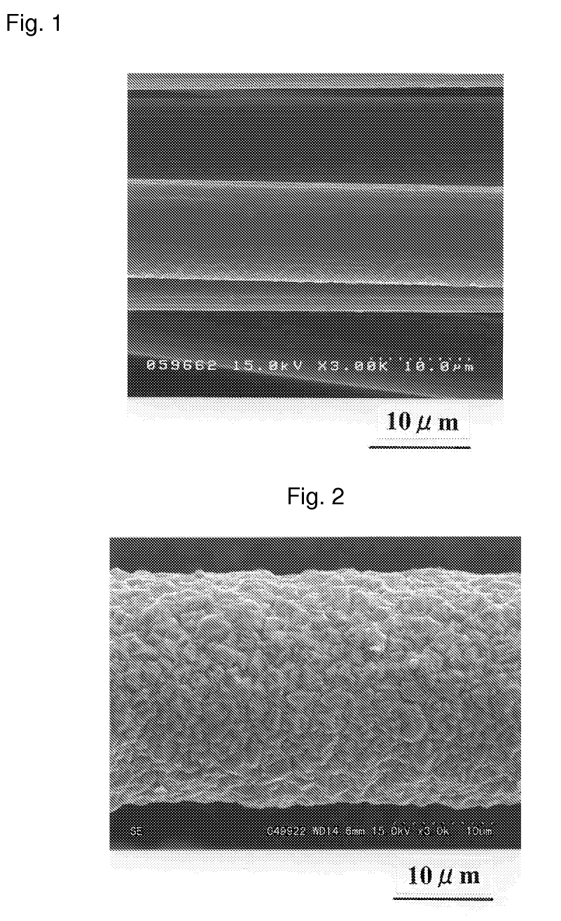

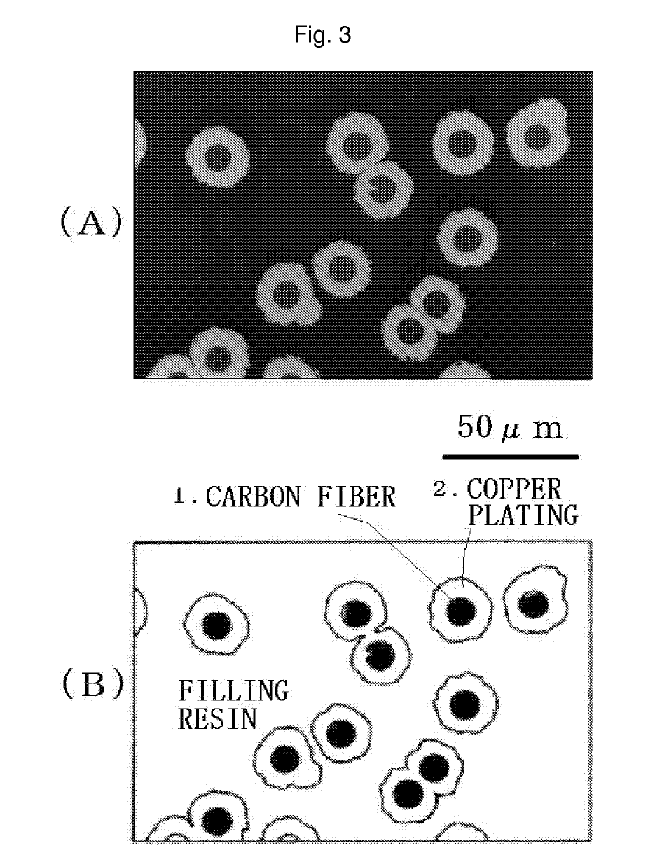

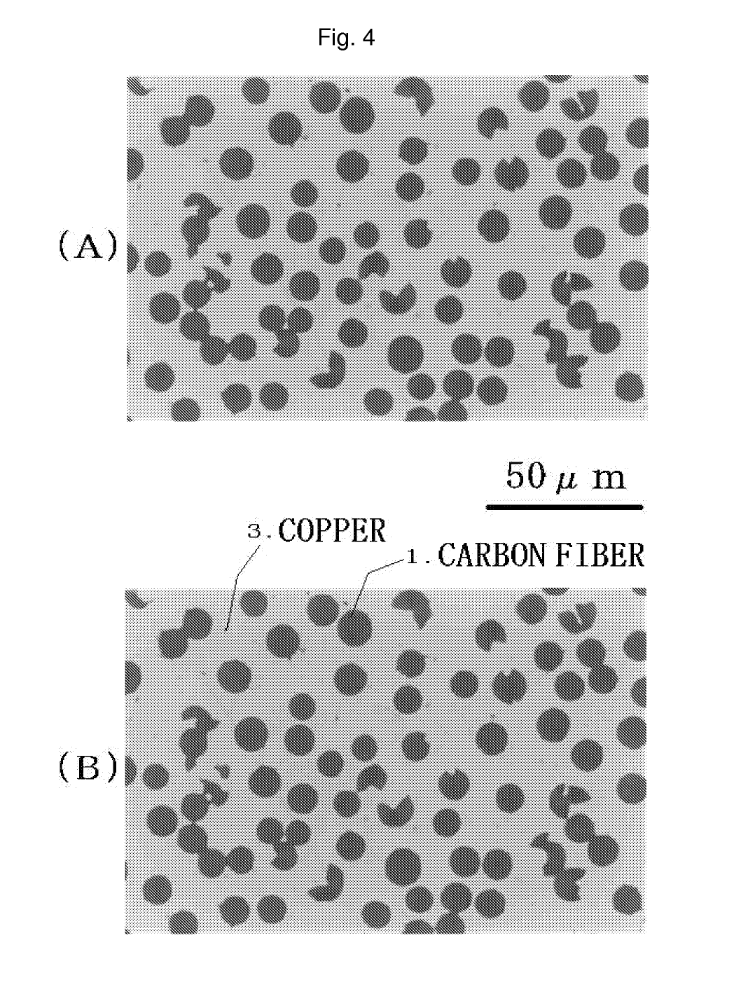

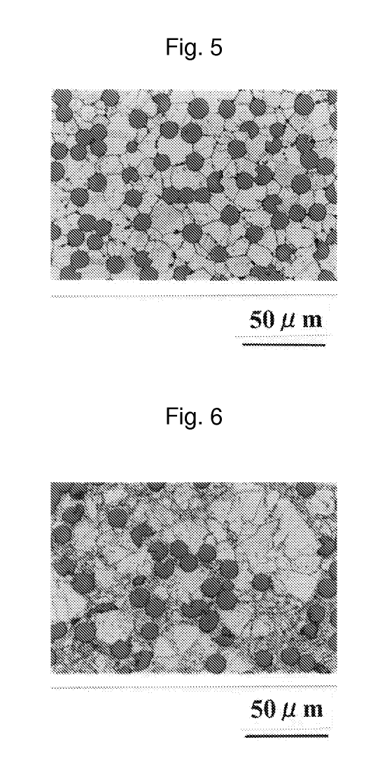

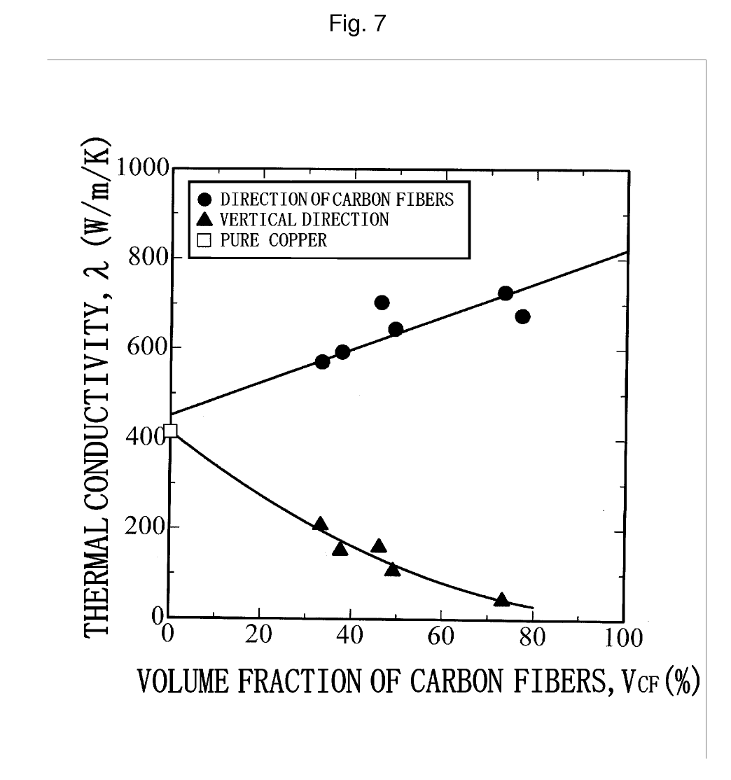

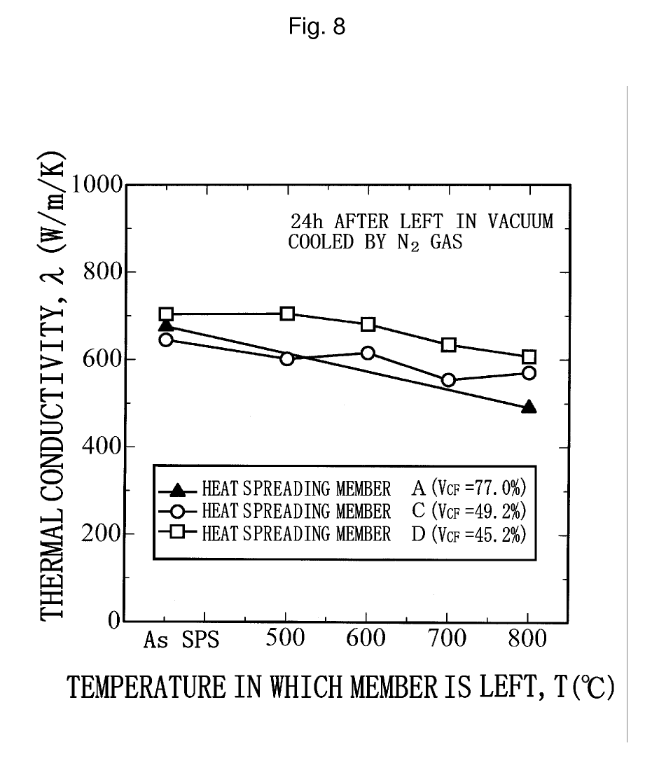

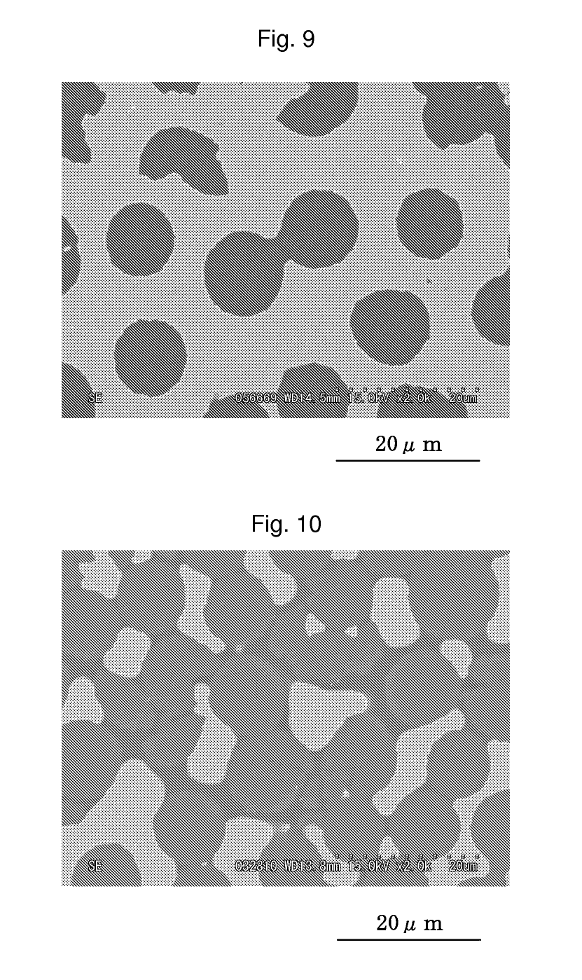

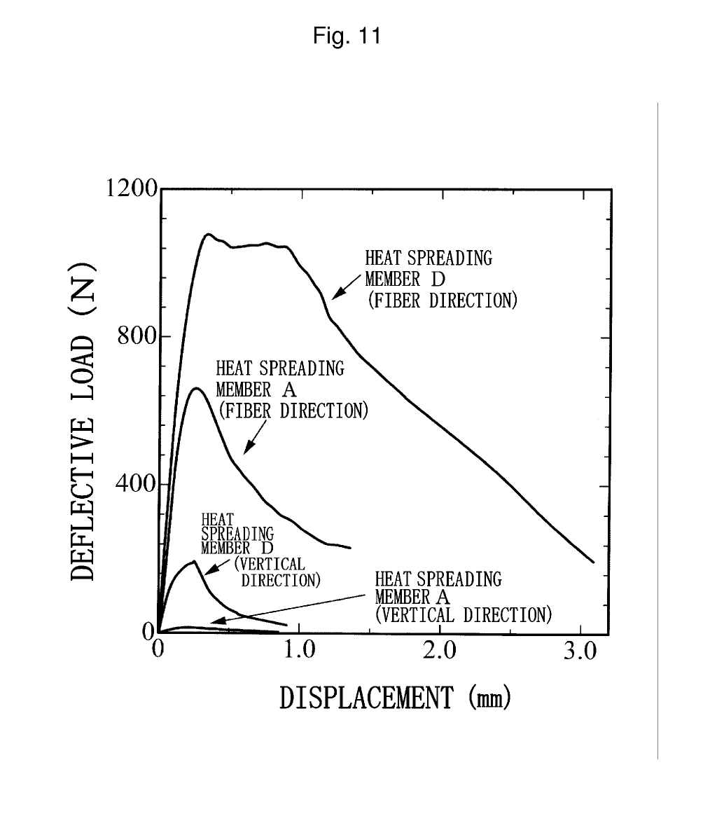

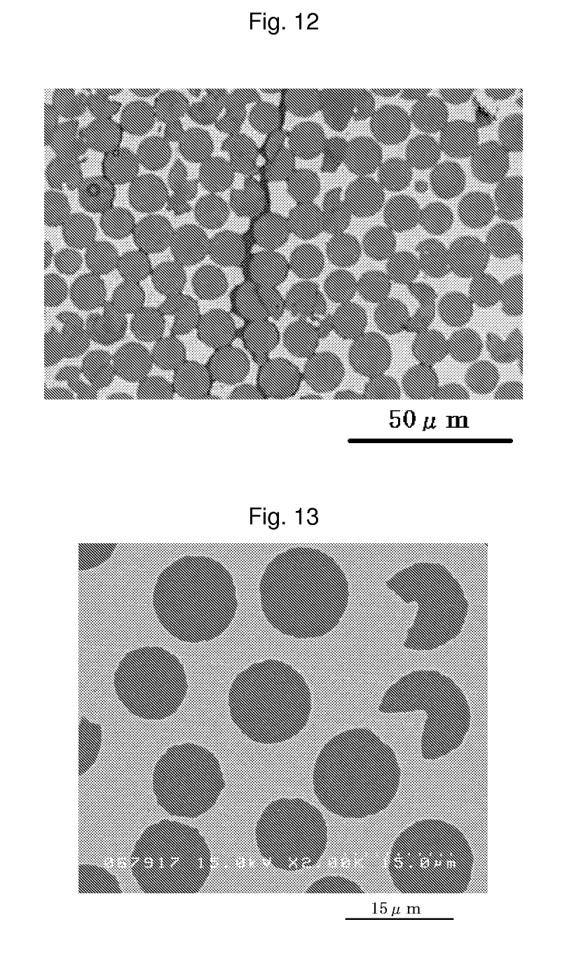

### EXPLANATIONS OF LETTERS OR NUMERALS

1 : CARBON FIBER, 2: COPPER PLATING, 3: COPPER

1-8. (canceled)

9. A heat spreading member composed of a composite material of carbon fibers aligned substantially in one direction and copper, characterized in that a metal structure of the copper in the heat spreading member is a recrystallized structure.

10. The heat spreading member according to claim 9, characterized in that an average crystal grain size of the recrystallized structure is 0.1 μm to 20 μm.

11. The heat spreading member according to claim 9, characterized in that a volume fraction V_{CF} of a portion of the carbon fibers in the heat spreading member is 30 percent to 90 percent.

12. The heat spreading member according to claim 9, characterized in that the volume fraction V_{CF} of a portion of the carbon fibers in the heat spreading member is 30 percent to 60 percent.

13. The heat spreading member according to claim 9, characterized in that at least one carbon fiber is present in any of 50 μm square portions in a field of view in a section perpendicular to a direction of the carbon fibers.

14. The heat spreading member according to claim 9, characterized in that the section perpendicular to the direction of the carbon fibers is not smaller than 1 mm square.

15. The heat spreading member according to claim 9, characterized in that a relation
ρ/{ρ_{CF}×(V_{CF}/100)+ρ_{CU}×(V_{CU}/100)}≧0.9
is satisfied, where p (Mg/m³) is density of the heat spreading member, ρ_{CF}(Mg/m³) is density of the carbon fibers, V_{CF} (%) is the volume fraction of the carbon fibers, ρ_{CU} (Mg/m³) is density of the copper, and V_{CU} (%) (=100-V_{CF}) is an apparent volume fraction of the copper.

16. The heat spreading member according to claim 9, wherein an average crystal grain size of the recrystallized structure is 0.1 μm to 20 μm,
the volume fraction V_{CF} of a portion of the carbon fibers in the heat spreading member is 30 percent to 60 percent,
the section perpendicular to the direction of the carbon fibers is not smaller than 1 mm square,
at least one carbon fiber is present in any of 50 μm square portions in a field of view in a section perpendicular to a direction of the carbon fibers, and, a relation
ρ/{ρ_{CF}×(V_{CF}/100)+ρ_{CU}×(V_{CU}/100)}≧0.9
is satisfied, where ρ(Mg/m³) is density of the heat spreading member, ρ_{CF}(Mg/m³) is density of the carbon fibers, V_{CF} (%) is the volume fraction of the carbon fibers, ρ_{CU} (Mg/m³) is density of the copper, and V_{CU} (%) (=100−V_{CF}) is an apparent volume fraction of the copper.

17. A manufacturing method of the heat spreading member according to claim 9, comprising:
plating copper on surfaces of carbon fibers of a diameter d_{CF} to a thickness of (0.05 to 0.60)×d_{CF};
aligning the plated carbon fibers substantially in one direction; and
performing spark plasma sintering on the aligned plated carbon fibers and recrystallizing a metal structure of the copper under conditions of 600° C. to 1050° C. in a highest temperature, 5 MPa to 100 MPa in a highest pressure, and 0.1 ks to 1.8 ks in a time length of a period when the highest temperature is maintained in ±5° C.
